(19) United States
(12) Patent Application Publication
(10) Pub. No.: US 2012/0019141 A1
(43) Pub. Date: Jan. 26, 2012

(54) EMERGENCY LIGHTING FOR AN ELEVATOR CAB

(76) Inventor: Bruno Beignet, Saint Gondon (FR)

(21) Appl. No.: 13/258,106

(22) PCT Filed: Jun. 29, 2009
(86) PCT No.: PCT/IB09/53238

§ 371 Date: Sep. 21, 2011

(51) Int. Cl. H05B 37/04

(52) U.S. Cl. 315/76

(57) ABSTRACT

An exemplary elevator lighting device includes a display panel that is activated during elevator operation to provide a display of selected information. A backlight portion illuminates the display panel during elevator operation to make the selected information visible on the display panel. The backlight portion receives power from a primary power source during elevator operation. The backlight portion receives power from a backup power source when power from the primary power source is discontinued. The backlight portion illuminates the display panel during the power loss condition to provide light in a vicinity of the device such as within an elevator cab.

### BACKGROUND

Elevators include a cab that carries passengers between different levels of a building, for example. Depending on the elevator system, an elevator cab may have various interior features. For example, many elevator cabs include a car operating panel that allows a passenger to provide an indication of the floor to which she desires to be carried. Other elevator cabs in destination entry elevator systems do not have a car operating panel because the passengers provide an indication of their desired destination at a kiosk outside of the elevator cab.

Regardless of the style of elevator cab, it is necessary to provide at least some light within the cab during all situations including power failures or elevator system failures. There are a variety of known emergency light configurations that are useful within elevator cabs. Most arrangements include a dedicated light source that is turned on during a power failure to provide at least some low level of light within the elevator cab. One such device is shown in U.S. Pat. No. 4,708,223. Another proposed arrangement is shown in U.S. Pat. No. 4,013,993. In that document, a florescent light that is part of a car operating panel operates as an emergency light source.

### SUMMARY

An exemplary elevator lighting device includes a display panel that is activated during elevator operation to provide a display of selected information and a backlight portion that illuminates the display panel. During elevator operation the backlight portion receives power from a primary power source and makes the selected information visible on the display panel. In the event the power from the primary power source is discontinued, the backlight portion receives power from a backup power source and illuminates the display panel to provide light in a vicinity of the device such as within an elevator cab.

An exemplary method of providing emergency lighting in an elevator cab during a power loss includes illuminating a display panel to provide selected information using a main power supply during elevator operation. The display panel is illuminated as an emergency source of light in the elevator cab using a backup power supply in the event power from the main power supply is discontinued.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 diagrammatically illustrates selected portions of an elevator cab including a lighting device designed according to an embodiment of this invention.

FIG. 2 illustrates the example of FIG. 1 providing an emergency lighting function.

FIG. 3 schematically shows an example arrangement for controlling the operation of an example embodiment of a lighting device.

FIG. 4 schematically shows selected features of an example backlight portion.

FIG. 5 schematically shows another example lighting device.

FIG. 6 schematically shows selected portions of another example elevator cab and lighting device.

### DETAILED DESCRIPTION

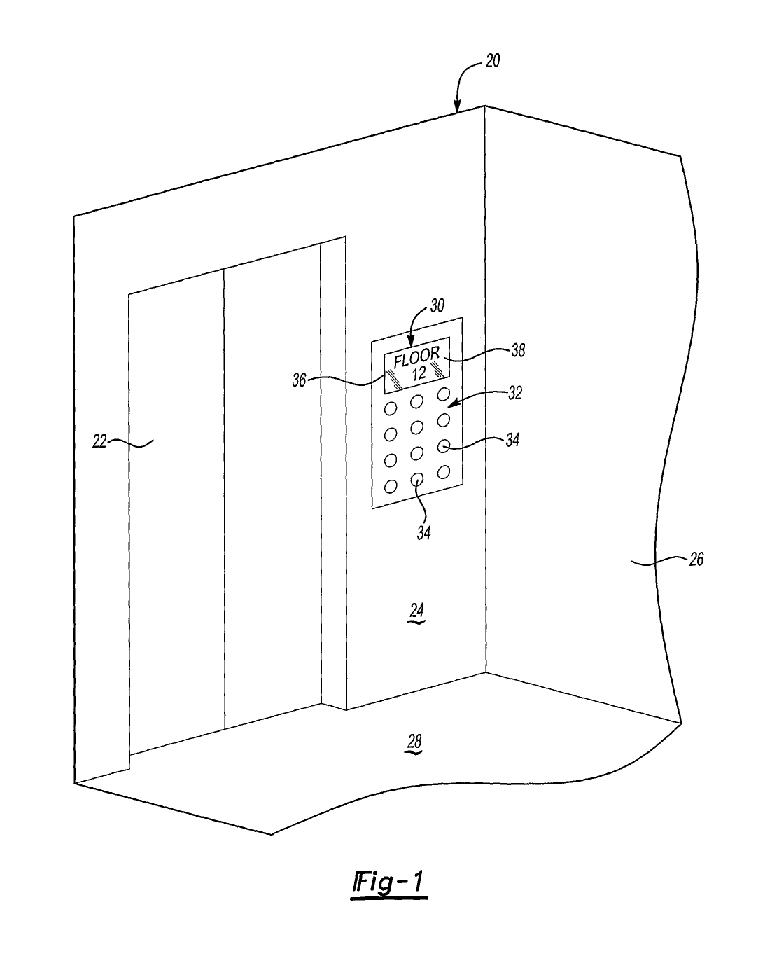

FIG. 1 schematically shows selected portions of an elevator cab 20 including doors 22, interior walls 24 and 26 and a floor 28. An elevator lighting device 30 is supported on the wall 24 in this example. The lighting device 30 is not used to light the interior of the cab 20 during normal elevator operation. Instead, separate lights (not illustrated) are used for normal lighting conditions. In the example of FIG. 1, the lighting device 30 is adjacent a car operating panel 32. A passenger input portion of the car operating panel 32 includes floor selector buttons 34 that allow passengers to indicate their desired destination floor.

The lighting device 30 includes a display panel 36 that shows selected information 38 for passengers regarding elevator service. For example, the selected information 38 may display a current floor at which the elevator cab 20 has stopped, the next floor at which the cab 20 will stop or other information that would be useful to a passenger within the cab 20.

During normal elevator operating conditions, the lighting device 30 is operated as desired to provide the selected information to passengers.

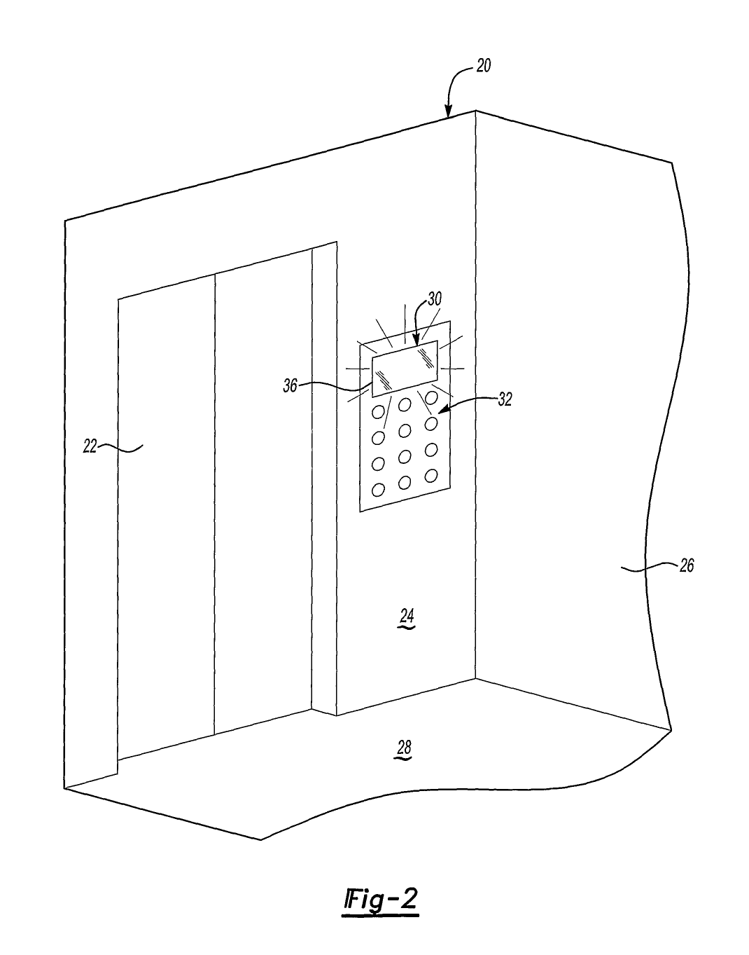

During a power failure the lighting device 30 operates as an emergency light source within the cab 20. As shown in FIG. 2, the lighting device 30 is illuminated to provide light at least within the vicinity of the display panel 36 to provide at least some amount of light within the elevator cab 20. As can be appreciated from FIG. 2, the display panel 36 is illuminated without having any of the normally displayed information associated with normal elevator operation on the display panel. In other words, the display panel 36 in this example is illuminated independent of operation or activation of the display panel and independent of any information on the display panel.

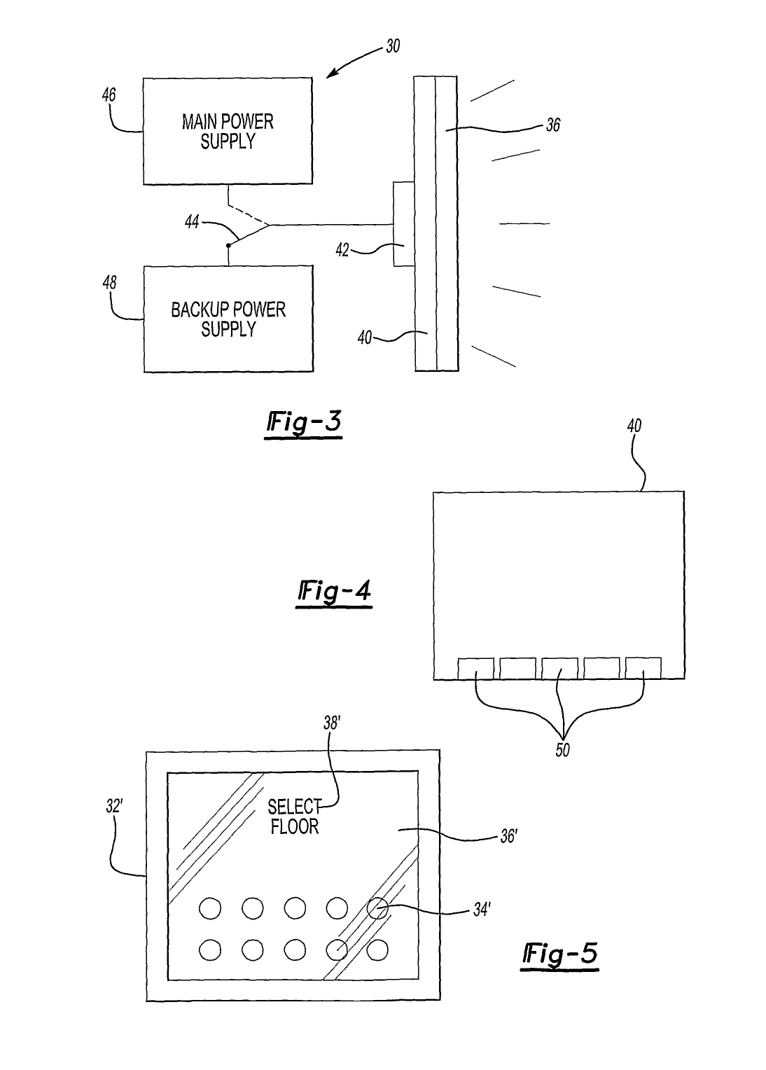

FIG. 3 schematically shows an example arrangement for controlling the lighting device 30. A backlight portion 40 provides illumination to the display panel 36. A controller portion 42 controls a switch 44 that is used for switching between a main power supply 46 and a backup power supply 48. During normal elevator operation, electrical power is available to components associated with the cab 20 through the traveling cable (not illustrated). The example main power supply 46 includes the electrical power provided through the traveling cable, for example. The backup power supply 48 in one example comprises a battery that is useful during situations where the main power supply 46 is not available and emergency lighting within the cab 20 is required. In this example, the controller portion 42 operates the switch 44 to couple the backlight portion 40 with the backup power supply 48 in the event of a power outage condition during which the main power supply 46 is not available.

During a power outage condition, the display panel 36 is not activated such that it does not provide any indication of any information to a passenger within the cab 20. In this example, the display panel 36 is configured to allow light from the backlight portion 40 to emanate through an entire surface of the display panel 36 in a manner that will provide emergency lighting within the interior of the elevator cab 20.

One example display panel 36 comprises a liquid crystal display panel. Some example display panel portions operate when activated to control where light from the backlight portion 40 is allowed to pass through the display panel 36. In this way the display panel 36 presents a visible image of the information for a passenger. When deactivated, the display panel 36 in the illustrated examples allows light through the entire surface of the display panel 36, which facilitates lighting the interior of the elevator cab 20 with enough light for an emergency situation.

One example backlight portion 40 comprises an electroluminescent panel. Another example backlight portion 40 comprises at least one light emitting diode. FIG. 4 schematically shows an example backlight portion 40 including a plurality of light emitting diodes 50. Using light emitting diodes 50 provides the advantage of low power consumption and no need for a converter as the light emitting diodes can operate using the direct current power available from a backup power supply 48 such as a battery.

In the example of FIGS. 1 and 2, a separate passenger input portion of the car operating panel 32 comprises components such as the buttons 34 that are distinct from the lighting device 30 and the display panel 36. In the example of FIG. 5 a lighting device provides the functionality of a car operating panel 32′ because the display panel 36′ is a touch screen that includes a passenger input panel 34′ and a display portion that displays selected information 38′. In the example of FIG. 5, during normal elevator operation the display on the display panel 36′ can be reconfigured based upon the current elevator operating conditions to provide different types of passenger information 38′ and a variety of configurations for a passenger input portion 34′. During a power outage condition, the display panel 36′ does not provide an indication of any information or any passenger input selections. Instead, during a power outage condition the display panel 36′ of the example of FIG. 5 is deactivated so that the backlight portion associated with the display panel 36′ illuminates the entire surface area of the display panel 36′ to provide emergency lighting within the elevator cab 20.

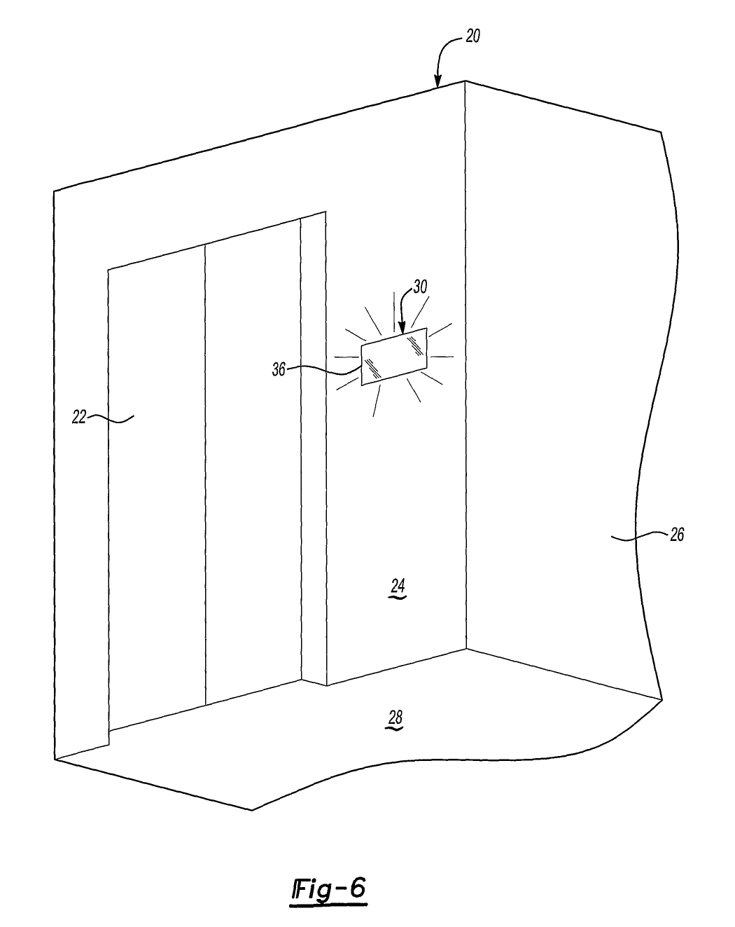

Another example elevator cab configuration is shown in FIG. 6. This example is useful in a destination entry type elevator system where passengers provide an indication of their desired destination outside of an elevator cab. In this example, the lighting device 30 is the only device on the wall 24 of the cab 20. There is no car operating panel because passengers are not permitted to make floor selections once they enter the cab 20. In this example, the lighting device 30 provides a display of selected passenger information on the display panel 36 during normal elevator operating conditions. As shown in FIG. 6, the display panel 36 is illuminated to provide emergency lighting within the cab 20. During such a condition, the display panel 36 will be deactivated so that no information is displayed on the display panel 36. Instead, the display panel 36 in this example is configured to allow light from a backlight portion 40 (see FIG. 3, for example) to pass through and illuminate the entire surface of the display panel 36.

The disclosed examples provide an economical and efficient source of emergency lighting within an elevator cab. Using a backlight portion associated with a display panel already in the elevator cab eliminates the requirement for providing separate, dedicated emergency lighting components. Additionally, utilizing a light source such as light emitting diodes of a backlight portion provides power savings compared to emergency light sources such as incandescent bulbs or florescent bulbs. Backlight sources such as light emitting diodes do not introduce any concerns regarding heat generation that is present, for example, within incandescent bulbs. Additionally, light emitting diodes are less expensive than florescent lights.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. An elevator lighting device, comprising:
a display panel that is activated during elevator operation to provide a display of selected information; and
a backlight portion that illuminates the display panel,
wherein during elevator operation the backlight portion receives power from a primary power source and makes the selected information visible on the display panel, and
wherein, in the event the power from the primary power source is discontinued, the backlight portion receives power from a backup power source and illuminates the display panel to provide light in a vicinity of the device.

2. The device of claim 1, wherein the backlight portion comprises at least one light emitting diode.

3. The device of claim 1, wherein the backlight portion comprises a plurality of light emitting diodes.

4. The device of claim 1, wherein the backlight portion comprises an electroluminescent panel.

5. The device of claim 1, wherein the display panel comprises a liquid crystal display panel.

6. The device of claim 1, comprising an elevator car operating panel having a passenger input interface configured to allow a passenger to enter information regarding a desired elevator service and wherein the display panel is distinct from the passenger input interface.

7. The device of claim 1, wherein the display panel comprises a touch screen panel that is configured to allow a passenger to enter information regarding a desired elevator service.

8. The device of claim 1, wherein the display panel is configured to allow light from the backlight portion to pass through an entire surface of the display panel independent of displaying any information during the power loss condition.

9. The device of claim 1, wherein the device is supported within an elevator cab and the backlight portion provides emergency lighting within the elevator cab during the power loss condition.

10. The device of claim 1, wherein the backlight portion illuminates the display panel in the event the power from the primary power source is discontinued independent of the display panel being activated.

11. The device of claim 10, wherein the display panel is deactivated in the event the power from the primary power source is discontinued.

12. A method of providing emergency lighting in an elevator cab, comprising the steps of:
illuminating a display panel to provide selected information using a main power supply during elevator operation; and
illuminating the display panel as an emergency source of light in the elevator cab using a backup power supply in the event power from the main power supply is discontinued.

13. The method of claim 12, comprising
allowing light through an entire surface of the display panel when illuminating the display panel as an emergency source of light in the elevator cab.

14. The method of claim 12, comprising
powering a backlight portion using the main power supply during elevator operation; and
powering the backlight portion using the backup power supply responsive to the power loss condition.

15. The method of claim 14, wherein the backlight portion comprises at least one light emitting diode.

16. The method of claim 14, wherein the backlight portion comprises a plurality of light emitting diodes.

17. The method of claim 12, wherein the display panel comprises a liquid crystal display panel.

18. The method of claim 12, comprising illuminating the display panel as an emergency source of light independent of any selected information on the display panel.

19. The method of claim 18, wherein the display panel is deactivated.
